(19) United States
(12) Patent Application Publication
(10) Pub. No.: US 2025/0126652 A1
(43) Pub. Date: Apr. 17, 2025

(54) A PRACH RADIO RECEIVER DEVICE WITH A NEURAL NETWORK, AND RELATED METHODS AND COMPUTER PROGRAMS

(71) Applicant: Nokia Solutions and Networks Oy, Espoo (FI)

(72) Inventors: Aliye KAYA, Murray Hill, NJ (US); Harish VISWANATHAN, Murray Hill, NJ (US); Luiz Fernando MEDEIROS, Espoo (FI)

(21) Appl. No.: 18/726,066

(22) PCT Filed: Jan. 10, 2022
(86) PCT No.: PCT/EP2022/050316

§ 371 Date: Jul. 1, 2024

(51) Int. Cl. H04W 74/0833; H04L 27/26

(52) U.S. Cl. CPC H04W 74/0833; H04L 27/2605

(57) ABSTRACT

Physical random access channel (PRACH) radio receiver devices and related methods and computer programs are disclosed. An uplink (UL) synchronization signal is received at a radio receiver device. The UL synchronization signal comprises a PRACH preamble. The PRACH preamble comprises a preamble sequence set. The radio receiver device extracts the preamble sequence set. The radio receiver device applies a neural network (NN) to the extracted preamble sequence set to determine a physical root sequence index, an associated cyclic shift value, and/or a timing offset value, for at least one preamble sequence instance in the extracted preamble sequence set. The radio receiver device further applies the NN to output at least one of the determined physical root sequence index, the associated cyclic shift value, and/or the timing offset value, for the at least one preamble sequence instance in the extracted preamble sequence set.

### TECHNICAL FIELD

The disclosure relates generally to communications and, more particularly but not exclusively, to a physical random access channel (PRACH) radio receiver device with a neural network, as well as related methods and computer programs.

### BACKGROUND

In cellular communication networks, such as fifth generation (5G) new radio (NR) wireless networks, a physical random access channel (PRACH) preamble is sent by a user equipment (UE) to a base station (BS) to obtain uplink (UL) synchronization. In 5G NR, there is a maximum of 64 preambles defined for a preamble set used by base stations. Thus, at a time t one may choose certain 64 preambles to compose the set. At another time t+1, one may choose another set of 64 preambles. The UE may choose a random preamble or a specific preamble to transmit from the preamble set. The preamble comprises a cyclic prefix (CP) and one or more preamble sequences. The UE may choose one of these 64 preambles to transmit a message to start an initial access procedure.

Each preamble set is uniquely identified using an initial logical root sequence and a parameter indicating cyclic shift to be used for consecutive logical root sequences to generate up to 64 preambles. More specifically, a preamble sequence is identified by the specific root sequence and the cyclic shift applied to it. The preambles in a preamble set are uniquely identified by the root sequence of the first root sequence and cyclic shift value.

In current networks, these root sequences are allocated through operator network planning between adjacent cells at deployment. In other words, current networks use a fixed allocation scheme, and it needs to be redone each time a new cell is added or cells are reconfigured. In other words, preamble sets are fixed during the operation of a cell.

However, at least in some situations, such a static allocation approach may lead to PRACH capacity shortfall due to the non-adaptive allocation of PRACH sequences.

### SUMMARY

The scope of protection sought for various example embodiments of the invention is set out by the independent claims. The example embodiments and features, if any, described in this specification that do not fall under the scope of the independent claims are to be interpreted as examples useful for understanding various example embodiments of the invention.

An example embodiment of a radio receiver device comprises at least one processor, at least one memory including computer program code, and at least one receive antenna. The at least one memory and the computer program code are configured to, with the at least one processor, cause the radio receiver device at least to perform receiving, over a physical random-access channel, PRACH, via one or more of the at least one receive antenna, at least one uplink, UL, synchronization signal. Each of the at least one UL synchronization signal comprises a PRACH preamble, and the PRACH preamble comprises a set of at least one instance of a preamble sequence. The at least one memory and the computer program code are further configured to, with the at least one processor, cause the radio receiver device to perform extracting the set of the at least one instance of the preamble sequence. The at least one memory and the computer program code are further configured to, with the at least one processor, cause the radio receiver device to perform processing the extracted set of the at least one instance of the preamble sequence. The processing of the extracted set of the at least one instance of the preamble sequence comprises applying a neural network, NN, to the extracted set of the at least one instance of the preamble sequence. The NN comprises at least one of a fully connected layer, a recurrent neural network layer, or a convolutional neural network layer. The NN is executable to determine at least one of a physical root sequence index, an associated cyclic shift value, a timing offset value, or any combination thereof, for at least one instance of the preamble sequence in the extracted set of the at least one instance of the preamble sequence. The NN is further executable to output at least one of the determined at least one of the physical root sequence index, the associated cyclic shift value, the timing offset value, or the any combination thereof, for the at least one instance of the preamble sequence in the extracted set of the at least one instance of the preamble sequence.

In an example embodiment, alternatively or in addition to the above-described example embodiments, the NN is executable to output at least the physical root sequence index and the associated cyclic shift value, and the at least one memory and the computer program code are further configured to, with the at least one processor, cause the radio receiver device to perform determining a logical preamble index for the at least one instance of the preamble sequence in the extracted set of the at least one instance of the preamble sequence based on the output physical root sequence index and the associated cyclic shift value.

In an example embodiment, alternatively or in addition to the above-described example embodiments, the NN is further executable to determine the physical root sequence index for the at least one instance of the preamble sequence in the extracted set of the at least one instance of the preamble sequence based on a first set of configuration information indicating a predetermined subset of applicable physical root sequence indices among which to limit the determination of the physical root sequence index.

In an example embodiment, alternatively or in addition to the above-described example embodiments, the first set of configuration information comprises a first vector indicating the predetermined subset of applicable physical root sequence indices.

In an example embodiment, alternatively or in addition to the above-described example embodiments, the NN is further executable to determine the associated cyclic shift value for the at least one instance of the preamble sequence in the extracted set of the at least one instance of the preamble sequence based on a second set of configuration information indicating a predetermined subset of applicable associated cyclic shift values among which to limit the determination of the associated cyclic shift value.

In an example embodiment, alternatively or in addition to the above-described example embodiments, the second set of configuration information comprises a second vector indicating the predetermined subset of applicable associated cyclic shift values.

In an example embodiment, alternatively or in addition to the above-described example embodiments, input dimensions of the NN correspond to at least one of a length of the preamble sequence, a number of radio receiver chains in the radio receiver device, a number of the instances of the preamble sequence in the set of the at least one instance of the preamble sequence, or a number of in-phase components and quadrature components, for the at least one instance of the preamble sequence in the extracted set of the at least one instance of the preamble sequence.

In an example embodiment, alternatively or in addition to the above-described example embodiments, the at least one memory and the computer program code are further configured to, with the at least one processor, cause the radio receiver device to perform training the NN by feeding the NN at least one of arbitrary PRACH sequences, the first set of configuration information using training data, or the second set of configuration information using training data.

In an example embodiment, alternatively or in addition to the above-described example embodiments, the training data in at least one of the first set of configuration information or the second set of configuration information spans multiple signal-to-noise ratio, SNR, values and channel instantiations from different channel models.

In an example embodiment, alternatively or in addition to the above-described example embodiments, the at least one memory and the computer program code are further configured to, with the at least one processor, cause the radio receiver device to perform the training of the NN further by minimizing weighted sum-losses of the physical root sequence indices, cyclic prefix identifiers, and time of arrival values.

In an example embodiment, alternatively or in addition to the above-described example embodiments, the at least one memory and the computer program code are further configured to, with the at least one processor, cause the radio receiver device to perform using a loss function for the physical root sequence indices and the cyclic prefix identifiers in the minimizing of the weighted sum-losses.

In an example embodiment, alternatively or in addition to the above-described example embodiments, the at least one memory and the computer program code are further configured to, with the at least one processor, cause the radio receiver device to perform using a distance-based loss for the time of arrival values in the minimizing of the weighted sum-losses.

In an example embodiment, alternatively or in addition to the above-described example embodiments, the NN comprises at least one of a convolutional neural network, a fully connected neural network, or recurrent neural network.

In an example embodiment, alternatively or in addition to the above-described example embodiments, the radio receiver device comprises a multiple-input and multiple-output, MIMO, capable radio receiver device.

In an example embodiment, alternatively or in addition to the above-described example embodiments, the radio receiver device is comprised in a network node device.

An example embodiment of a radio receiver device comprises means for performing: causing the radio receiver device to receive, over a physical random-access channel, PRACH, via one or more of the at least one receive antenna, at least one uplink, UL, synchronization signal. Each of the at least one UL synchronization signal comprises a PRACH preamble, and the PRACH preamble comprises a set of at least one instance of a preamble sequence. The means are further configured to perform extracting the set of the at least one instance of the preamble sequence. The means are further configured to perform processing the extracted set of the at least one instance of the preamble sequence. The processing of the extracted set of the at least one instance of the preamble sequence comprises applying a neural network, NN, to the extracted set of the at least one instance of the preamble sequence. The NN comprises at least one of a fully connected layer, a recurrent neural network layer, or a convolutional neural network layer. The NN is executable to determine at least one of a physical root sequence index, an associated cyclic shift value, a timing offset value, or any combination thereof, for at least one instance of the preamble sequence in the extracted set of the at least one instance of the preamble sequence. The NN is further executable to output at least one of the determined at least one of the physical root sequence index, the associated cyclic shift value, the timing offset value, or the any combination thereof, for the at least one instance of the preamble sequence in the extracted set of the at least one instance of the preamble sequence.

In an example embodiment, alternatively or in addition to the above-described example embodiments, the NN is executable to output at least the physical root sequence index and the associated cyclic shift value, and the means are further configured to perform determining a logical preamble index for the at least one instance of the preamble sequence in the extracted set of the at least one instance of the preamble sequence based on the output physical root sequence index and the associated cyclic shift value.

In an example embodiment, alternatively or in addition to the above-described example embodiments, the NN is further executable to determine the physical root sequence index for the at least one instance of the preamble sequence in the extracted set of the at least one instance of the preamble sequence based on a first set of configuration information indicating a predetermined subset of applicable physical root sequence indices among which to limit the determination of the physical root sequence index.

In an example embodiment, alternatively or in addition to the above-described example embodiments, the first set of configuration information comprises a first vector indicating the predetermined subset of applicable physical root sequence indices.

In an example embodiment, alternatively or in addition to the above-described example embodiments, the NN is further executable to determine the associated cyclic shift value for the at least one instance of the preamble sequence in the extracted set of the at least one instance of the preamble sequence based on a second set of configuration information indicating a predetermined subset of applicable associated cyclic shift values among which to limit the determination of the associated cyclic shift value.

In an example embodiment, alternatively or in addition to the above-described example embodiments, the second set of configuration information comprises a second vector indicating the predetermined subset of applicable associated cyclic shift values.

In an example embodiment, alternatively or in addition to the above-described example embodiments, input dimensions of the NN correspond to at least one of a length of the preamble sequence, a number of radio receiver chains in the radio receiver device, a number of the instances of the preamble sequence in the set of the at least one instance of the preamble sequence, or a number of in-phase components and quadrature components, for the at least one instance of the preamble sequence in the extracted set of the at least one instance of the preamble sequence.

In an example embodiment, alternatively or in addition to the above-described example embodiments, the means are further configured to perform training the NN by feeding the NN at least one of arbitrary PRACH sequences, the first set of configuration information using training data, or the second set of configuration information using training data.

In an example embodiment, alternatively or in addition to the above-described example embodiments, the training data in at least one of the first set of configuration information or the second set of configuration information spans multiple signal-to-noise ratio, SNR, values and channel instantiations from different channel models.

In an example embodiment, alternatively or in addition to the above-described example embodiments, the means are further configured to perform the training of the NN further by minimizing weighted sum-losses of the physical root sequence indices, cyclic prefix identifiers, and time of arrival values.

In an example embodiment, alternatively or in addition to the above-described example embodiments, the means are further configured to perform using a loss function for the physical root sequence indices and the cyclic prefix identifiers in the minimizing of the weighted sum-losses.

In an example embodiment, alternatively or in addition to the above-described example embodiments, the means are further configured to perform using a distance-based loss for the time of arrival values in the minimizing of the weighted sum-losses.

In an example embodiment, alternatively or in addition to the above-described example embodiments, the NN comprises at least one of a convolutional neural network, a fully connected neural network, or recurrent neural network.

In an example embodiment, alternatively or in addition to the above-described example embodiments, the radio receiver device comprises a multiple-input and multiple-output, MIMO, capable radio receiver device.

In an example embodiment, alternatively or in addition to the above-described example embodiments, the radio receiver device is comprised in a network node device.

An example embodiment of a method comprises receiving, at a radio receiver device over a physical random-access channel, PRACH, via at least one receive antenna of the radio receiver device, at least one uplink, UL, synchronization signal. Each of the at least one UL synchronization signal comprises a PRACH preamble, and the PRACH preamble comprises a set of at least one instance of a preamble sequence. The method further comprises extracting, by the radio receiver device, the set of the at least one instance of the preamble sequence. The method further comprises applying, by the radio receiver device, a neural network, NN, to the extracted set of the at least one instance of the preamble sequence to determine at least one of a physical root sequence index, an associated cyclic shift value, a timing offset value, or any combination thereof, for at least one instance of the preamble sequence in the extracted set of the at least one instance of the preamble sequence. The NN comprises at least one of a fully connected layer, a recurrent neural network layer, or a convolutional neural network layer. The method further comprises applying, by the radio receiver device, the NN to output at least one of the determined at least one of the physical root sequence index, the associated cyclic shift value, the timing offset value, or the any combination thereof, for the at least one instance of the preamble sequence in the extracted set of the at least one instance of the preamble sequence.

In an example embodiment, alternatively or in addition to the above-described example embodiments, the NN is executable to output at least the physical root sequence index and the associated cyclic shift value, and the method further comprises determining, by the radio receiver device, a logical preamble index for the at least one instance of the preamble sequence in the extracted set of the at least one instance of the preamble sequence based on the output physical root sequence index and the associated cyclic shift value.

In an example embodiment, alternatively or in addition to the above-described example embodiments, the NN is further executable to determine the physical root sequence index for the at least one instance of the preamble sequence in the extracted set of the at least one instance of the preamble sequence based on a first set of configuration information indicating a predetermined subset of applicable physical root sequence indices among which to limit the determination of the physical root sequence index.

In an example embodiment, alternatively or in addition to the above-described example embodiments, the first set of configuration information comprises a first vector indicating the predetermined subset of applicable physical root sequence indices.

In an example embodiment, alternatively or in addition to the above-described example embodiments, the NN is further executable to determine the associated cyclic shift value for the at least one instance of the preamble sequence in the extracted set of the at least one instance of the preamble sequence based on a second set of configuration information indicating a predetermined subset of applicable associated cyclic shift values among which to limit the determination of the associated cyclic shift value.

In an example embodiment, alternatively or in addition to the above-described example embodiments, the second set of configuration information comprises a second vector indicating the predetermined subset of applicable associated cyclic shift values.

In an example embodiment, alternatively or in addition to the above-described example embodiments, input dimensions of the NN correspond to at least one of a length of the preamble sequence, a number of radio receiver chains in the radio receiver device, a number of the instances of the preamble sequence in the set of the at least one instance of the preamble sequence, or a number of in-phase components and quadrature components, for the at least one instance of the preamble sequence in the extracted set of the at least one instance of the preamble sequence.

In an example embodiment, alternatively or in addition to the above-described example embodiments, the method further comprises training, by the radio receiver device, the NN by feeding the NN at least one of arbitrary PRACH sequences, the first set of configuration information using training data, or the second set of configuration information using training data.

In an example embodiment, alternatively or in addition to the above-described example embodiments, the training data in at least one of the first set of configuration information or the second set of configuration information spans multiple signal-to-noise ratio, SNR, values and channel instantiations from different channel models.

In an example embodiment, alternatively or in addition to the above-described example embodiments, the method further comprises performing, by the radio receiver device, the training of the NN further by minimizing weighted sum-losses of the physical root sequence indices, cyclic prefix identifiers, and time of arrival values.

In an example embodiment, alternatively or in addition to the above-described example embodiments, the method further comprises using, by the radio receiver device, a loss function for the physical root sequence indices and the cyclic prefix identifiers in the minimizing of the weighted sum-losses.

In an example embodiment, alternatively or in addition to the above-described example embodiments, the method further comprises using, by the radio receiver device, a distance-based loss for the time of arrival values in the minimizing of the weighted sum-losses.

In an example embodiment, alternatively or in addition to the above-described example embodiments, the NN comprises at least one of a convolutional neural network, a fully connected neural network, or recurrent neural network.

In an example embodiment, alternatively or in addition to the above-described example embodiments, the radio receiver device comprises a multiple-input and multiple-output, MIMO, capable radio receiver device.

In an example embodiment, alternatively or in addition to the above-described example embodiments, the radio receiver device is comprised in a network node device.

An example embodiment of a computer program comprises instructions for causing a radio receiver device to perform at least the following: receiving, over a physical random-access channel, PRACH, via at least one receive antenna of the radio receiver device, at least one uplink, UL, synchronization signal. Each of the at least one UL synchronization signal comprises a PRACH preamble, and the PRACH preamble comprises a set of at least one instance of a preamble sequence. The computer program further comprises instructions for causing the radio receiver device to perform extracting the set of the at least one instance of the preamble sequence. The computer program further comprises instructions for causing the radio receiver device to perform applying a neural network, NN, to the extracted set of the at least one instance of the preamble sequence to determine at least one of a physical root sequence index, an associated cyclic shift value, a timing offset value, or any combination thereof, for at least one instance of the preamble sequence in the extracted set of the at least one instance of the preamble sequence. The NN comprises at least one of a fully connected layer, a recurrent neural network layer, or a convolutional neural network layer. The computer program further comprises instructions for causing the radio receiver device to perform applying the NN to output at least one of the determined at least one of the physical root sequence index, the associated cyclic shift value, the timing offset value, or the any combination thereof, for the at least one instance of the preamble sequence in the extracted set of the at least one instance of the preamble sequence.

### DESCRIPTION OF THE DRAWINGS

The accompanying drawings, which are included to provide a further understanding of the embodiments and constitute a part of this specification, illustrate embodiments and together with the description help to explain the principles of the embodiments. In the drawings:

FIG. 1A shows an example embodiment of the subject matter described herein illustrating an example system, where various embodiments of the present disclosure may be implemented;

FIG. 1B illustrates an example of a messaging exchange in a 5G NR initial access procedure;

FIG. 2 shows an example embodiment of the subject matter described herein illustrating a radio receiver device;

FIG. 3 shows an example embodiment of the subject matter described herein illustrating a neural network-based radio receiver device;

FIG. 4 shows an example embodiment of the subject matter described herein illustrating inputs and outputs to the neural network of the radio receiver device;

FIG. 5 shows an example embodiment of the subject matter described herein illustrating a universal deep neural network of the radio receiver device;

FIG. 6 shows an example embodiment of the subject matter described herein illustrating training of the neural network of the radio receiver device;

FIG. 7 shows an example embodiment of the subject matter described herein illustrating data collection of the neural network of the radio receiver device; and

FIG. 8 shows an example embodiment of the subject matter described herein illustrating a method.

Like reference numerals are used to designate like parts in the accompanying drawings.

### DETAILED DESCRIPTION

Reference will now be made in detail to embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

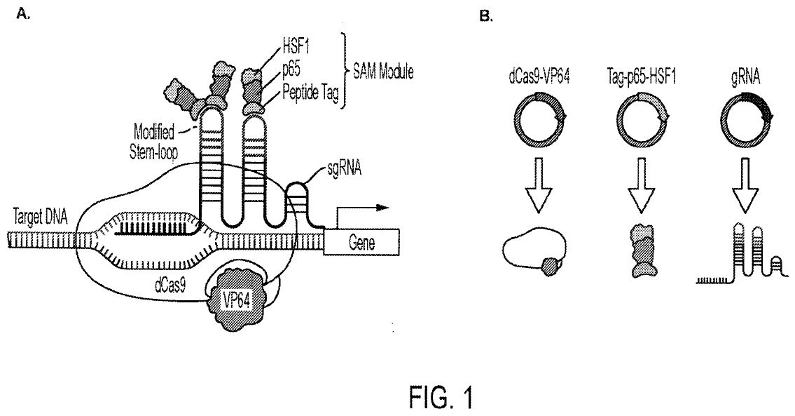

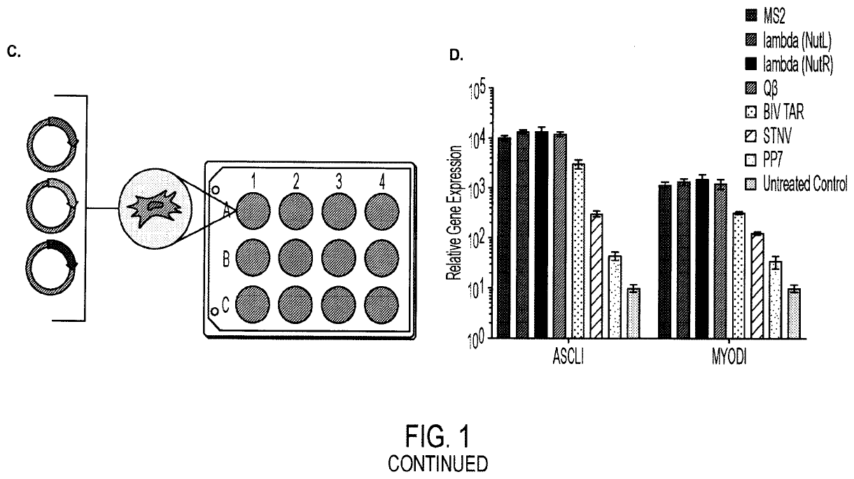

FIG. 1A illustrates an example system 100, where various embodiments of the present disclosure may be implemented. The system 100 may comprise a fifth generation (5G) new radio (NR) network 110. An example representation of the system 100 is shown depicting a client device 130 and a network node device 120. At least in some embodiments, the 5G NR network 110 may comprise one or more massive machine-to-machine (M2M) network(s), massive machine type communications (mMTC) network(s), internet of things (IoT) network(s), industrial internet-of-things (IIoT) network(s), enhanced mobile broadband (eMBB) network(s), ultra-reliable low-latency communication (URLLC) and/or the like. In other words, the 5G NR network 110 may be configured to serve diverse service types and/or use cases, and it may logically be seen as comprising one or more networks.

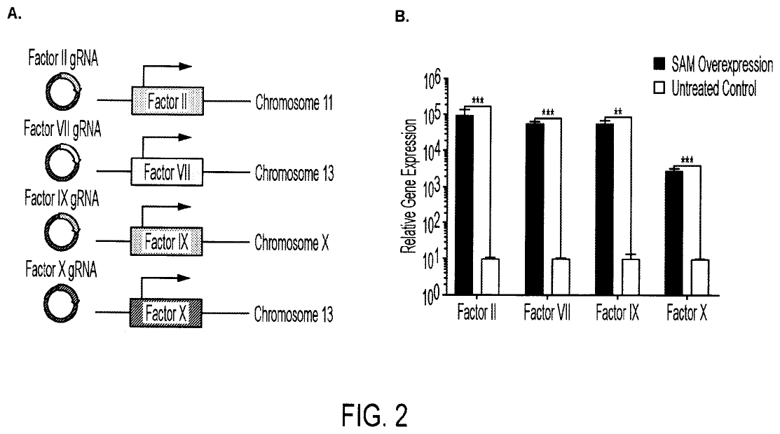

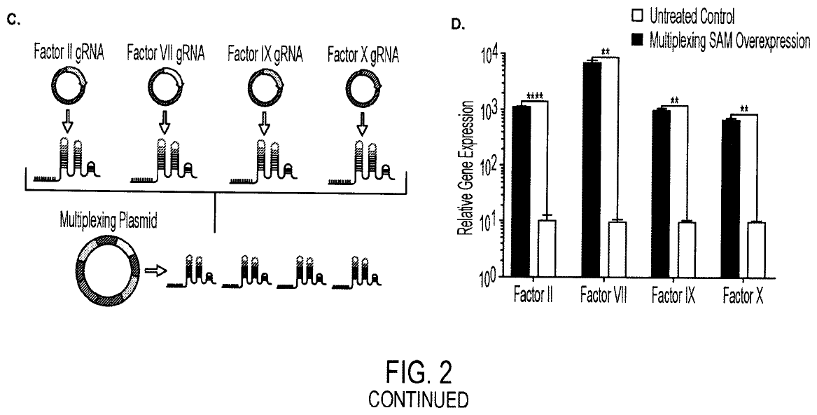

The client device 130 may include, e.g., a mobile phone, a smartphone, a tablet computer, a smart watch, or any hand-held, portable and/or wearable device. The client device 130 may also be referred to as a user equipment (UE). The network node device 120 may comprise a base station. The base station may include, e.g., a fifth-generation base station (gNB) or any such device suitable for providing an air interface for client devices to connect to a wireless network via wireless transmissions. The network node device 120 may comprise a radio receiver device 200 of FIG. 2.

In 5G NR, a synchronization signal block (SSB) may carry a primary synchronization signal and a secondary synchronization signal, as well as a primary broadcast channel (PBCH) to support multibeam operations. SSB blocks may be transmitted with some periodicity, e.g., 20 milliseconds (ms) in 5 ms long bursts including multiple SSB blocks in a set. After beam sweeping, the client device 130 may extract remaining minimum system information (RMSI) from the selected SSB. The RMSI may include a random-access channel configuration (RACH). Multiple SSBs may be configured to have the same RMSI. The network may configure an association between SSBs, RACH resources, and preamble indices, e.g., to helps the network node device 120 in determining the best downlink (DL) beam to use for a specific client device 130.

FIG. 1B illustrates an example of a messaging exchange in a 5G NR initial access procedure.

At operation 141, the client device 130 may send a message 1 which may include its randomly chosen orthogonal PRACH preamble. The client device 130 may uniquely identify the set of possible preambles from the RMSI.

The network node device 120 may decode the message 1 from the client device 130 and extract its PRACH preamble. At operation 142, the network node device 120 may send a message 2 (random access response) to the client device 130 which may include, e.g., timing advance information.

At operation 143, the client device 130 may send a message 3 using the received timing advance information on its designated uplink beams. The message 3 may comprise, e.g., a radio resource control (RRC) connection request and an identifier of the client device 130.

At operation 144, the network node device 120 may send a message 4 to client device 130 which may include, e.g., RRC setup information, and the identifier of the client device 130 extracted from the message 3.

At least in some implementations in 5G NR, decoding the message 1 from a client device and extracting its PRACH preamble has typically been implemented by using a correlator. In these implementations, the received preamble sequences may be correlated with a dictionary of preamble sequences. The preamble sequence with the highest correlation value above a threshold indicates the presence of a preamble signal transmitted by a client device 130. A network node device may obtain the time of arrival information from the correlation with the correct preamble sequence, and the timing advance information may be calculated from this.

The PRACH preambles used in operation 141 may be generated using, e.g., Zadoff-Chu sequences. Basically, a PRACH preamble is a cyclic-shifted version of a root sequence. There are N−1 unique root sequences for a preamble length of N. For example, for a PRACH sequence length of 139 there are 138 unique root sequences.

A maximum of 64 preambles has been defined for each PRACH time-frequency occasion. The client device 130 may choose one of these preambles to transmit its message 1.

The initial root sequence and the cyclic prefix used uniquely determines the set of 64 preambles as follows:

The set of random-access preambles x_{u,v}(n) shall be generated according to

$${x}_{u , v} ( n ) = {x}_{u} ( ( n + {C}_{v} ) mod {L}_{RA} )$$

$${x}_{u} ( i ) = {e}^{- j \frac{π u i ( i + 1 )}{{L}_{RA}}} , i = 0 , 1 , … , {L}_{RA} - 1$$

from which the frequency-domain representation shall be generated according to

$${y}_{u , v} ( n ) = {\sum }_{m = 0}^{{L}_{RA} - 1} {x}_{u , v} ( m ) \cdot {e}^{- j \frac{2 π mn}{{L}_{RA}}}$$

where L_{RA}=839, L_{RA}=139, L_{RA}=1151, or L_{RA}=571 depending on the PRACH preamble format.

There are 64 preambles defined in each time-frequency PRACH occasion, enumerated in an increasing order of a first increasing cyclic shift Cᵥ of a logical root sequence, and then in an increasing order of a logical root sequence index, starting with an index obtained from a higher-layer parameter prach-RootSequenceIndex or rootSequenceIndex-BFR or by msgA-prach-RootSequenceIndex, if configured, and a type-2 random-access procedure may be initiated. Additional preamble sequences, in case 64 preambles cannot be generated from a single root Zadoff-Chu sequence, may be obtained from the root sequences with the consecutive logical indexes until all the 64 sequences have been determined. The logical root sequence order may be cyclic, such that the logical index 0 is consecutive to L_{RA}−2. The sequence number u may be obtained from the logical root sequence index.

Thus, the cyclic shift Cᵥ may be given by

$${C}_{v} = \{ \begin{matrix}{vN}_{CS} & v = 0 , 1 , … , ⌊ {L}_{RA} / {N}_{CS} ⌋ - 1 , {N}_{CS} \neq 0 & for unrestricted sets \\ 0 & {N}_{CS} = 0 & for unrestricted sets \\ {d}_{start} ⌊ v / {n}_{shift}^{RA} ⌋ + ( v mod {n}_{shift}^{RA} ) {N}_{CS} & v = 0 , 1 , … , w - 1 & \begin{matrix}for restricted sets \\ type A and B\end{matrix} \\ {{d}^{=}}_{start} + ( v - w ) {N}_{CS} & v = w , … , w + {{n}^{=}}_{shift}^{RA} - 1 & \begin{matrix}for restricted sets \\ type B\end{matrix} \\ {\overline{\overline{\overline{d}}}}_{start} + ( v - w - {\overline{\overline{n}}}_{shift}^{RA} ) {N}_{CS} & v = w + {{n}^{=}}_{shift}^{RA} , … , w + {{n}^{=}}_{shift}^{RA} + {{n}^{=}}_{shift}^{RA} - 1 & \begin{matrix}for restricted sets \\ type B\end{matrix}\end{matrix}$$

$$w = {n}_{shift}^{RA} {n}_{group}^{RA} + {\overline{n}}_{shift}^{RA}$$

in which N_{CS} may be predetermined, the higher-layer parameter restrictedSetConfig may determine the type of restricted sets (e.g., unrestricted, restricted type A, restricted type B), and the type of restricted sets supported for the different preamble formats may be predetermined.

In the following, various example embodiments will be discussed. At least some of these example embodiments may allow a neural network-based radio receiver device 200 in which the neural network is trained (e.g., universally) to perform preamble sequence detection for any preamble set. Such a neural network-based radio receiver device 200 may be implemented in any network node device 120 for PRACH detection and time of arrival (TOA) estimation. The neural network in the radio receiver device 200 does not need to be trained for any specific preamble set, but instead may work for any preamble set. Therefore, it may be deployed at any network node device for any preamble set. Accordingly, at least some of the example embodiments may allow dynamic allocation of root sequences.

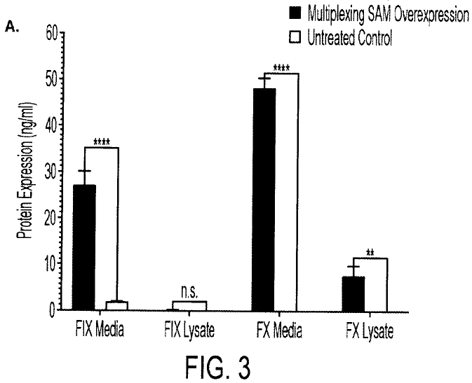

In other words, at least some of the example embodiments may allow a neural network-based scheme to implement the PRACH detection and timing offset estimation, as illustrated in diagram 300 of FIG. 3, in which a signal 302 received by the radio receiver device 200 and corresponding to a signal 301 transmitted by the client device 130 is transferred via antennas 206A, 206B, front-end processing blocks 303A, 303B, and a demapper 304 in order to feed extracted preamble sequences directly to the neural network 305 without need for combining repetitions of the preamble sequences or any other processing. The output 306 of the neural network comprises a physical root sequence index, its cyclic shift and a timing offset value, based on which the radio receiver device 200 may generate its output 307, including a logical preamble index and the timing offset value.

FIG. 2 is a block diagram of the radio receiver device 200, in accordance with an example embodiment.

The radio receiver device 200 comprises one or more processors 202, one or more memories 204 that comprise computer program code. The radio receiver device 200 may be configured to receive information from other devices. In one example, the radio receiver device 200 may receive signaling information and data in accordance with at least one cellular communication protocol. The radio receiver device 200 may be configured to provide at least one wireless radio connection, such as for example a 3GPP mobile broadband connection (e.g., 5G). The radio receiver device 200 further comprises at least one receive antenna 206 to receive radio frequency signals. For example, the at least one receive antenna 206 may comprise a logical receive antenna.

Although the radio receiver device 200 is depicted to include only one processor 202, the radio receiver device 200 may include more processors. In an embodiment, the memory 204 is capable of storing instructions, such as an operating system and/or various applications. Furthermore, the memory 204 may include a storage that may be used to store, e.g., at least some of the information and data used in the disclosed embodiments, such as a neural network (NN) 305 described in more detail below.

Furthermore, the processor 202 is capable of executing the stored instructions. In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, a neural network chip, an artificial intelligence (AI) accelerator, or the like. In an embodiment, the processor 202 may be configured to execute hard-coded functionality. In an embodiment, the processor 202 is embodied as an executor of software instructions, wherein the instructions may specifically configure the processor 202 to perform the algorithms and/or operations described herein when the instructions are executed.

It is also possible to train one machine learning model with a specific architecture, then derive another machine learning model from that using processes such as compilation, pruning, quantization or distillation. The machine learning model can be executed using any suitable apparatus, for example a CPU, GPU, ASIC, FPGA, compute-in-memory, analogue, or digital, or optical apparatus. It is also possible to execute the machine learning model in an apparatus that combines features from any number of these, for instance digital-optical or analogue-digital hybrids. In some examples, the weights and required computations in these systems may be programmed to correspond to the machine learning model. In some examples, the apparatus may be designed and manufactured so as to perform the task defined by the machine learning model so that the apparatus is configured to perform the task when it is manufactured without the apparatus being programmable as such.

The memory 204 may be embodied as one or more volatile memory devices, one or more non-volatile memory devices, and/or a combination of one or more volatile memory devices and non-volatile memory devices. For example, the memory 204 may be embodied as semiconductor memories (such as mask ROM, PROM (programmable ROM), EPROM (erasable PROM), flash ROM, RAM (random access memory), etc.).

The radio receiver device 200 may comprise any of various types of digital devices capable of receiving radio communication in a wireless network. At least in some embodiments, the radio receiver device 200 may be comprised in a base station, such as a fifth-generation base station (gNB) or any such device providing an air interface for client devices 130 to connect to the wireless network via wireless transmissions. At least in some embodiments, the radio receiver device 200 may comprise a multiple-input and multiple-output (MIMO) capable radio receiver device, such as a massive MIMO capable radio receiver device. In other embodiments, the radio receiver device 200 may comprise a single antenna radio receiver device, such as an IoT device, or any radio receiver device in which initial access or synchronization is needed. At least in some embodiments, the radio receiver device 200 may be comprised in the network node device 120.

The at least one memory 204 and the computer program code are configured to, with the at least one processor 202, cause the radio receiver device 200 at least to perform receiving, over a physical random-access channel (PRACH) via one or more of the at least one receive antenna 206, at least one uplink (UL) synchronization signal. For example, the at least one UL synchronization signal may comprise a UL synchronization signal for establishing an initial access or for calibrating a timing offset after establishing the initial access.

Each of the at least one UL synchronization signal comprises a PRACH preamble, and the PRACH preamble comprises a set of at least one instance of a preamble sequence. Herein, the term “instance” indicates that when there are multiple instances of the preamble sequence in the PRACH preamble, those instances are copies (i.e., repetitions) of each other. In other words, the PRACH preamble may comprise a single preamble sequence or multiple repetitions of the same preamble sequence. The PRACH preamble may be received from one or multiple (e.g., logical) receive antennas 206. When there are R repetitions of the same preamble sequence and N receive antennas, there may be R×N instances of that preamble sequence. Each instance may be impacted by different channel conditions. Therefore, they may not all be the same. Generally, an objective of a PRACH radio receiver device is to detect which PRACH preamble is sent based on the received preamble sequence(s).

The at least one memory 204 and the computer program code are further configured to, with the at least one processor 202, cause the radio receiver device 200 to perform extracting the set of the at least one instance of the preamble sequence.

The at least one memory 204 and the computer program code are further configured to, with the at least one processor 202, cause the radio receiver device 200 to perform processing the extracted set of the at least one instance of the preamble sequence.

The processing of the extracted set of the at least one instance of the preamble sequence comprises applying a neural network (NN) 305 to the extracted set of the at least one instance of the preamble sequence.

The NN 305 comprises a fully connected layer, a recurrent neural network layer, and/or a convolutional neural network layer. In other words, the NN 305 may comprise a convolutional neural network, a fully connected neural network, and/or recurrent neural network.

The NN 305 is executable to determine a physical root sequence index, an associated cyclic shift value, a timing offset value, and/or any combination thereof (such as {root sequence index, cyclic shift value}, {root sequence index, cyclic shift value, timing offset value}, {cyclic shift value, timing offset value}, and/or {root sequence index, timing offset value}), for at least one instance of the preamble sequence in the extracted set of the at least one instance of the preamble sequence.

At least in some embodiments, the NN 305 may be further executable to determine the physical root sequence index for the at least one instance of the preamble sequence in the extracted set of the at least one instance of the preamble sequence based on a first set of configuration information indicating a predetermined subset of applicable physical root sequence indices among which to limit the determination of the physical root sequence index. For example, the first set of configuration information may comprise a first vector (e.g., a first binary vector) indicating the predetermined subset of applicable physical root sequence indices.

At least in some embodiments, the NN 305 may be further executable to determine the associated cyclic shift value for the at least one instance of the preamble sequence in the extracted set of the at least one instance of the preamble sequence based on a second set of configuration information indicating a predetermined subset of applicable associated cyclic shift values among which to limit the determination of the associated cyclic shift value. For example, the second set of configuration information may comprise a second vector (e.g., a second binary vector) indicating the predetermined subset of applicable associated cyclic shift values.

In other words, radio receiver device 200 may be configured with preambles sets used in the cell of the network node device 120, which may be used as configuration input to the neural network 305. Such an input may comprise, e.g., a binary vector with ones at indexes corresponding to configured cyclic shifts and root sequences. However, the configured preamble sets may be modified dynamically by simply changing the input to the neural network 305 without any change to the base station hardware or software. The new configuration may then be broadcast, e.g., via an SSB and made known to the client device 130.

For example, a preamble set may comprise 64 logical preamble sequences generated out of 32 root sequences. A configuration parameter called “preset” may comprise for each logical preamble sequence the specific root sequence index and its cyclic shift. The disclosed approach may use the “preset” to extract configuration vectors “R” and “C” which indicate to the neural network 305 to not look for preamble indexes not included in the preamble set. R may comprise, e.g., a binary vector derived from the configured preamble set with ones corresponding to the indexes of the physical root sequence values used in the preamble set, and C may comprise, e.g., a binary vector derived from the preamble set with ones corresponding to cyclic shift values. The same NN 305 may also be run with all the elements of R and C set to 1 as well with proper training.

The NN 305 is further executable to output at least one of the determined physical root sequence index, associated cyclic shift value, timing offset value, and/or the any combination thereof, for the at least one instance of the preamble sequence in the extracted set of the at least one instance of the preamble sequence.

In other words, the NN 305 may process the received PRACH signal samples and the (e.g., binary) vector inputs indicating the configured root sequences and cyclic shifts, and produce as output the cyclic shift and the root sequence used in the received signal, which uniquely identifies the preamble sequences.

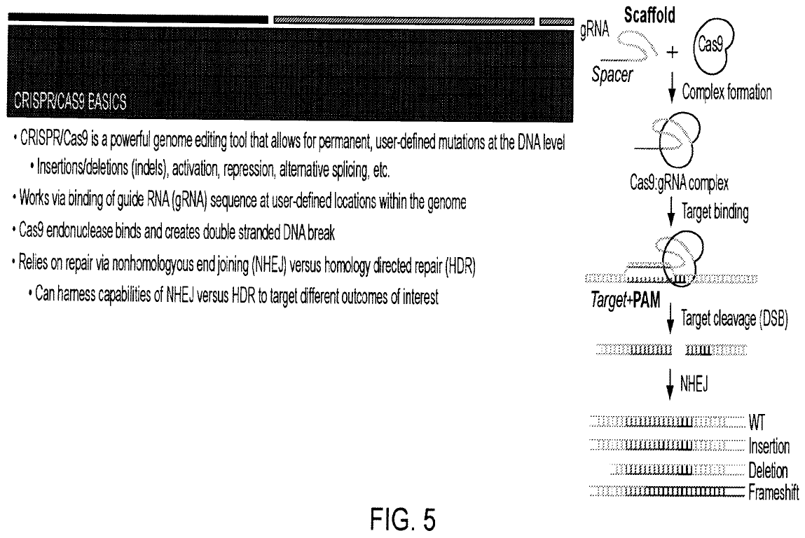

FIG. 5 illustrates an example layer structure of a universal deep neural network 305 of the radio receiver device 200. It may have, e.g., three inputs. The “main input” may comprise the received input extracted at the output of the demapper 304. The “second input” may comprise the R vector described above, and the “third input” may comprise the C vector described above. As can be seen, layers may include any of input layers, one-dimensional convolutional (Conv1D) layers and/or multi-dimensional convolutional layers, reshape layers, dropout layers, concatenate layers, flattening layers, and/or dense layers. Convolutional layers may be used for, e.g., generalization and/or feature creation. Fully connected layers and/or dense layers may bused for, e.g., direct mapping and/or feature creation. Reshape layers may be used for, e.g., changing the shape of a tensor. Concatenate layers may be used for, e.g., joining two tensors over a specific dimension.

At least in some embodiments, only one neural network 305 needs to be implemented in the radio receiver device 200 to detect any preamble set. This is more efficient than uploading a separate neural network for each and every preamble set used by sectors of the network node device 120 comprising the radio receiver device 200 to detect the logical preamble indexes. The size of the neural network 305 may be further reduced, e.g., when using binary vectors most coefficients may be zeros.

At least in some embodiments, the NN 305 may be executable to output at least the physical root sequence index and the associated cyclic shift value, and the at least one memory 204 and the computer program code may be further configured to, with the at least one processor 202, cause the radio receiver device 200 to perform determining a logical preamble index for the at least one instance of the preamble sequence in the extracted set of the at least one instance of the preamble sequence based on the output physical root sequence index and the associated cyclic shift value.

At least in some embodiments, input dimensions of the NN 305 may correspond to a length of the preamble sequence, a number of radio receiver chains in the radio receiver device 200, a number of the instances of the preamble sequence in the set of the at least one instance of the preamble sequence, and/or a number of in-phase components and quadrature components, for the at least one instance of the preamble sequence in the extracted set of the at least one instance of the preamble sequence.

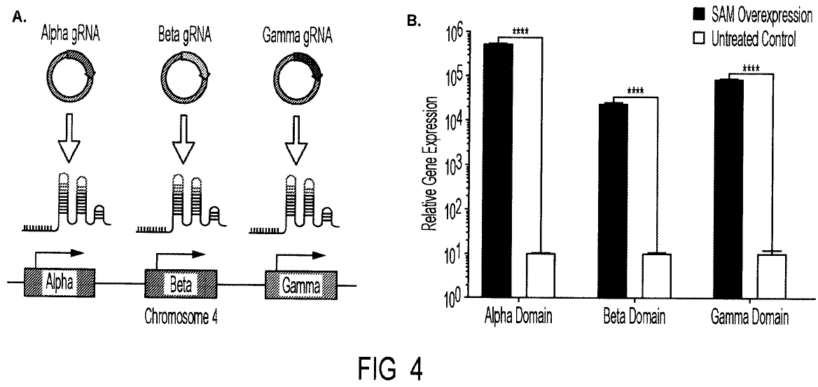

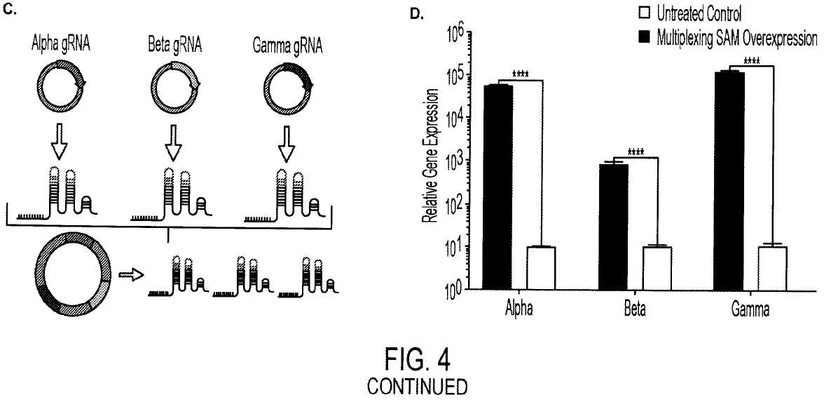

Diagram 400 of FIG. 4 illustrates examples of inputs and outputs to the neural network 305 of the radio receiver device 200. As discussed above, the input 401, 402 to the neural network 305 may have the dimensions {a length of the preamble sequence, a number of radio receiver chains in the radio receiver device 200, a number of the instances of the preamble sequence in the set of the at least one instance of the preamble sequence, and/or a number of in-phase components and quadrature components}. A single neural network 305 with proper dimensions may process the input for any number of receiver chains and repetitions. Therefore, the neural network 305 is independent of PRACH formatting which reduces the complexity and enables flexibility. The disclosed approach does not require coherent combining of repetitions, and it may process all of the receiver chains at once.

At least in some embodiments, the at least one memory 204 and the computer program code may be further configured to, with the at least one processor 202, cause the radio receiver device 200 to perform training the NN 305 by feeding the NN 305 arbitrary PRACH sequences, the first set of configuration information using training data, and/or the second set of configuration information using training data. For example, the training data may comprise simulated data, or measured data based on real scenarios in which the sequence sent, distance, and cyclic shift information are known.

For example, the training data in at least one of the first set of configuration information or the second set of configuration information may span multiple signal-to-noise ratio, SNR, values and channel instantiations from different channel models.

At least in some embodiments, the at least one memory 204 and the computer program code may be further configured to, with the at least one processor 202, cause the radio receiver device 200 to perform the training of the NN 305 further by minimizing weighted sum-losses of the physical root sequence indices, cyclic prefix identifiers, and time of arrival values.

At least in some embodiments, the at least one memory 204 and the computer program code may be further configured to, with the at least one processor 202, cause the radio receiver device 200 to perform using a loss function for the physical root sequence indices and the cyclic prefix identifiers in the minimizing of the weighted sum-losses. For example, the loss function may comprise a categorical loss function.

At least in some embodiments, the at least one memory 204 and the computer program code may be further configured to, with the at least one processor 202, cause the radio receiver device 200 to perform using a distance-based loss for the time of arrival values in the minimizing of the weighted sum-losses. At least in some embodiments, the distance-based loss may comprise a loss function which computes the distance between (Y, Ŷ), in which Y is the truth and Ŷ is an estimate of the truth. For example, the distance-based loss may comprise a minimum-square-error (MSE) loss.

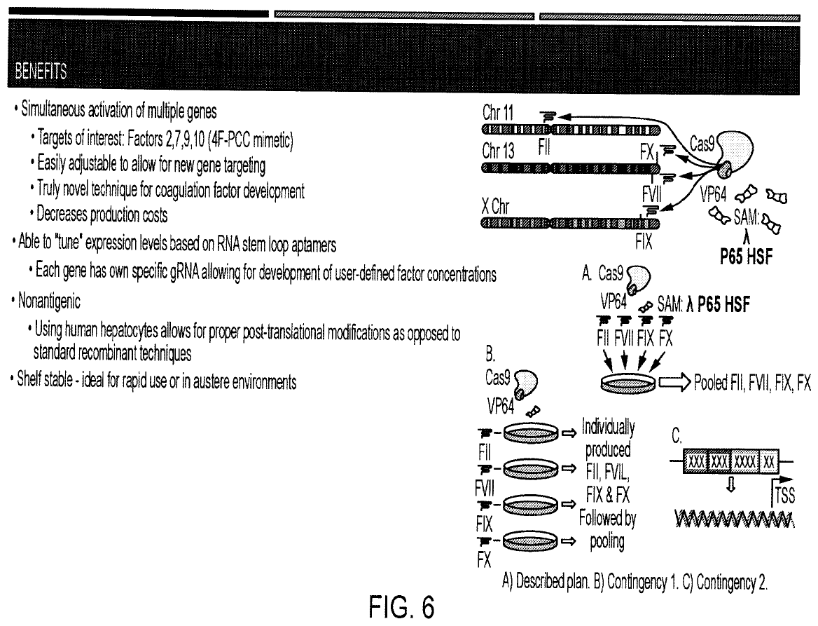

Diagram 600 of FIG. 6 illustrates an example of training of the neural network 305 of the radio receiver device 200. In this example, the neural network 305 may be trained by feeding arbitrary PRACH sequences 601 to the neural network 305 along with R and C vectors 602, 603 corresponding to the preamble set they belong to, by using, e.g., simulated data. The simulated data may span a large number of SNR values and channel instantiations from different channel models, to facilitate making the neural network 305 universal. The output 604 of neural network 305 may comprise a physical root sequence index (rID), a cyclic prefix ID (cyc), and the a time of arrival value (TOA). The output 604 may be compared with a ground truth 605, and the parameters of the neural network 305 may subsequently be tuned. For example, a categorical loss function may be used for the rID and the cyclic prefix. For the TOA, a minimum-square-error loss may be used, for example. The entire neural network 305 may be trained to minimize weighted sum-loss of these three values rID, cyc and TOA.

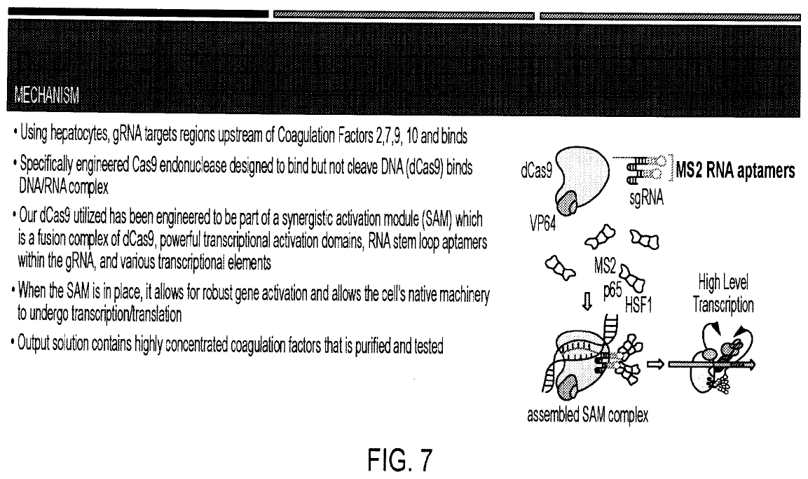

Diagram 700 of FIG. 7 illustrates an example of data collection of the neural network 305 of the radio receiver device 200. The data collection may be performed based on, e.g., data collected from field or from offline simulations using, e.g., a realistic simulator. Diagram 700 of FIG. 7 illustrates an example methodology to extract data. A simulation may be configured for specific channel configurations. At operation 701, the used preamble set may be varied by varying PRACHRootSequenceIndex and PRachZeroCorrelationConfig which are unique identifiers of the preamble set. Out of this set, a random preamble index may be drawn, operation 702. At operation 703, the simulation may be run with that preamble for a time interval. For each collected sequence, the timing offset may be determined. Each input sample S may be saved along with the R, C, rID, cyc and TOA.

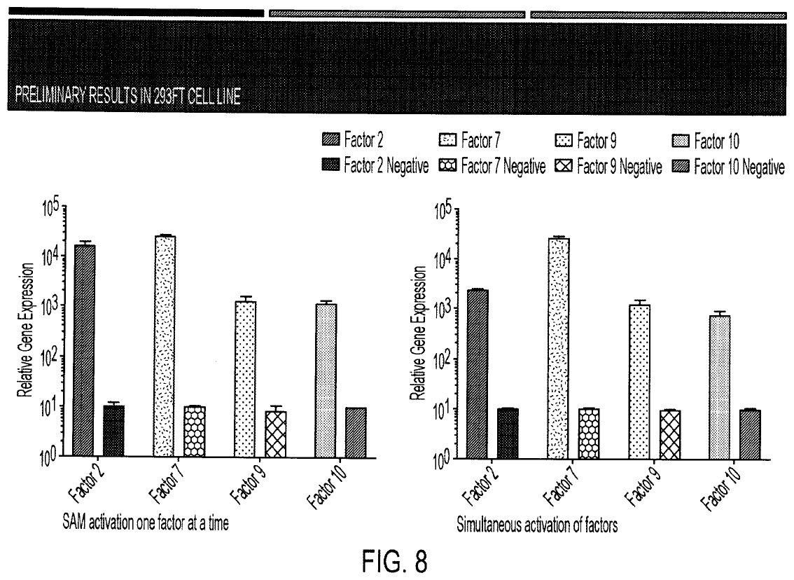

FIG. 8 illustrates an example flow chart of a method 800, in accordance with an example embodiment.

At optional operation 801, the radio receiver device 200 may train the NN 305 by feeding the NN 305 arbitrary PRACH sequences, the first set of configuration information using training data, and/or the second set of configuration information using training data.

At operation 802, the radio receiver device 200 receives at least one UL synchronization signal over the PRACH via at least one receive antenna of the radio receiver device. As discussed above in more detail, each of the at least one UL synchronization signal comprises a PRACH preamble, and the PRACH preamble comprises a set of at least one instance of a preamble sequence.

At operation 803, the radio receiver device 200 extracts the set of the at least one instance of the preamble sequence.

At operation 804, the radio receiver device 200 applies the NN 305 to the extracted set of the at least one instance of the preamble sequence to determine a physical root sequence index, an associated cyclic shift value, a timing offset value, and/or any combination thereof, for at least one instance of the preamble sequence in the extracted set of the at least one instance of the preamble sequence. As discussed above in more detail, the NN 305 comprises at least one of a fully connected layer, a recurrent neural network layer, or a convolutional neural network layer.

At operation 805, the radio receiver device 200 applies the NN 305 to output at least one of the determined physical root sequence index, associated cyclic shift value, timing offset value, and/or the any combination thereof, for the at least one instance of the preamble sequence in the extracted set of the at least one instance of the preamble sequence.

At optional operation 806, the radio receiver device 200 may determine a logical preamble index for the at least one instance of the preamble sequence in the extracted set of the at least one instance of the preamble sequence based on the output physical root sequence index and the associated cyclic shift value, when the NN 305 is executable to output at least the physical root sequence index and the associated cyclic shift value.

The method 800 may be performed by the radio receiver device 200 of FIG. 2. The operations 801-806 can, for example, be performed by the at least one processor 202 and the at least one memory 204. Further features of the method 800 directly result from the functionalities and parameters of the radio receiver device 200, and thus are not repeated here. The method 800 can be performed by computer program(s).

At least some of the embodiments described herein may not need to save/update root sequences at the radio receiver device 200. Since there's no need to save/update the root sequences at the radio receiver device 200, at least some of the embodiments described herein may allow new capabilities for a PRACH radio receiver device design, detection and planning.

Furthermore, at least some of the embodiments described herein may allow reducing the number of radio receiver device 200 instances to one independent of the number of SSBs and the preamble sets used across all SSBs.

Furthermore, at least some of the embodiments described herein may not need to have a specific NN 305 per subcell. This allows supporting very large beams with massive MIMO systems simultaneously while reducing the latency in initial access.

Furthermore, at least some of the embodiments described herein may not need to have multiple nested “for” loops in the radio receiver device 200 processing. The signals received at each antenna interface and with each repetition may be processed without need for coherent/non-coherent combining to reduce the dimension for a correlator. This may improve the detection of the PRACH preamble sequences.

The radio receiver device 200 may comprise means for performing at least one method described herein. In an example, the means may comprise the at least one processor 202, and the at least one memory 204 including program code configured to, when executed by the at least one processor 202, cause the radio receiver device 200 to perform the method.

The functionality described herein can be performed, at least in part, by one or more computer program product components such as software components. According to an embodiment, the radio receiver device 200 may comprise a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and Graphics Processing Units (GPUs).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A radio receiver device, comprising:
at least one processor;
at least one memory including computer program code; and
at least one receive antenna;
the at least one memory and the computer program code configured to, with the at least one processor, cause the radio receiver device at least to perform:
receiving, over a physical random-access channel, PRACH, via one or more of the at least one receive antenna, at least one uplink, UL, synchronization signal, each of the at least one UL synchronization signal comprising a PRACH preamble, the PRACH preamble comprising a set of at least one instance of a preamble sequence;
extracting the set of the at least one instance of the preamble sequence; and
processing the extracted set of the at least one instance of the preamble sequence,
wherein the processing of the extracted set of the at least one instance of the preamble sequence comprises applying a neural network, NN, to the extracted set of the at least one instance of the preamble sequence, the NN comprising at least one of a fully connected layer, a recurrent neural network layer, or a convolutional neural network layer, and the NN being executable to:
determine at least one of a physical root sequence index, an associated cyclic shift value, a timing offset value, or any combination thereof, for at least one instance of the preamble sequence in the extracted set of the at least one instance of the preamble sequence; and
output at least one of the determined at least one of the physical root sequence index, the associated cyclic shift value, the timing offset value, or the any combination thereof, for the at least one instance of the preamble sequence in the extracted set of the at least one instance of the preamble sequence.

2. The radio receiver device according to claim 1, wherein the NN is executable to output at least the physical root sequence index and the associated cyclic shift value, and the at least one memory and the computer program code are further configured to, with the at least one processor, cause the radio receiver device to perform determining a logical preamble index for the at least one instance of the preamble sequence in the extracted set of the at least one instance of the preamble sequence based on the output physical root sequence index and the associated cyclic shift value.

3. The radio receiver device according to claim 1, wherein the NN is further executable to determine the physical root sequence index for the at least one instance of the preamble sequence in the extracted set of the at least one instance of the preamble sequence based on a first set of configuration information indicating a predetermined subset of applicable physical root sequence indices among which to limit the determination of the physical root sequence index.

4. The radio receiver device according to claim 3, wherein the first set of configuration information comprises a first vector indicating the predetermined subset of applicable physical root sequence indices.

5. The radio receiver device according to claim 1, wherein the NN is further executable to determine the associated cyclic shift value for the at least one instance of the preamble sequence in the extracted set of the at least one instance of the preamble sequence based on a second set of configuration information indicating a predetermined subset of applicable associated cyclic shift values among which to limit the determination of the associated cyclic shift value.

6. The radio receiver device according to claim 5, wherein the second set of configuration information comprises a second vector indicating the predetermined subset of applicable associated cyclic shift values.

7. The radio receiver device according to claim 1, wherein input dimensions of the NN correspond to at least one of a length of the preamble sequence, a number of radio receiver chains in the radio receiver device, a number of the instances of the preamble sequence in the set of the at least one instance of the preamble sequence, or a number of in-phase components and quadrature components, for the at least one instance of the preamble sequence in the extracted set of the at least one instance of the preamble sequence.

8. The radio receiver device according to claim 5, wherein the at least one memory and the computer program code are further configured to, with the at least one processor, cause the radio receiver device to perform training the NN by feeding the NN at least one of arbitrary PRACH sequences, the first set of configuration information using training data, or the second set of configuration information using training data.

9. The radio receiver device according to claim 8, wherein the training data in at least one of the first set of configuration information or the second set of configuration information spans multiple signal-to-noise ratio, SNR, values and channel instantiations from different channel models.

10. The radio receiver device according to claim 8, wherein the at least one memory and the computer program code are further configured to, with the at least one processor, cause the radio receiver device to perform the training of the NN further by minimizing weighted sum-losses of the physical root sequence indices, cyclic prefix identifiers, and time of arrival values.

11. The radio receiver device according to claim 10, wherein the at least one memory and the computer program code are further configured to, with the at least one processor, cause the radio receiver device to perform using a loss function for the physical root sequence indices and the cyclic prefix identifiers in the minimizing of the weighted sum-losses.

12. The radio receiver device according to claim 10, wherein the at least one memory and the computer program code are further configured to, with the at least one processor, cause the radio receiver device to perform using a distance-based loss for the time of arrival values in the minimizing of the weighted sum-losses.

13. The radio receiver device according to claim 1, wherein the NN comprises at least one of a convolutional neural network, a fully connected neural network, or recurrent neural network.

14. The radio receiver device according to claim 1, wherein the radio receiver device comprises a multiple-input and multiple-output, MIMO, capable radio receiver device.

15. The radio receiver device according to claim 1, wherein the radio receiver device is comprised in a network node device (120).

16. A method, comprising:
receiving, at a radio receiver device over a physical random-access channel, PRACH, via at least one receive antenna of the radio receiver device, at least one uplink, UL, synchronization signal, each of the at least one UL synchronization signal comprising a PRACH preamble, the PRACH preamble comprising a set of at least one instance of a preamble sequence;
extracting, by the radio receiver device, the set of the at least one instance of the preamble sequence;
applying, by the radio receiver device, a neural network, NN, to the extracted set of the at least one instance of the preamble sequence to determine at least one of a physical root sequence index, an associated cyclic shift value, a timing offset value, or any combination thereof, for at least one instance of the preamble sequence in the extracted set of the at least one instance of the preamble sequence, the NN comprising at least one of a fully connected layer, a recurrent neural network layer, or a convolutional neural network layer; and
applying, by the radio receiver device, the NN to output at least one of the determined at least one of the physical root sequence index, the associated cyclic shift value, the timing offset value, or the any combination thereof, for the at least one instance of the preamble sequence in the extracted set of the at least one instance of the preamble sequence.

17. A computer program comprising instructions for causing a radio receiver device to perform at least the following:
receiving, over a physical random-access channel, PRACH, via at least one receive antenna of the radio receiver device, at least one uplink, UL, synchronization signal, each of the at least one UL synchronization signal comprising a PRACH preamble, the PRACH preamble comprising a set of at least one instance of a preamble sequence;
extracting the set of the at least one instance of the preamble sequence;
applying a neural network, NN, to the extracted set of the at least one instance of the preamble sequence to determine at least one of a physical root sequence index, an associated cyclic shift value, a timing offset value, or any combination thereof, for at least one instance of the preamble sequence in the extracted set of the at least one instance of the preamble sequence, the NN comprising at least one of a fully connected layer, a recurrent neural network layer, or a convolutional neural network layer; and
applying the NN to output at least one of the determined at least one of the physical root sequence index, the associated cyclic shift value, the timing offset value, or the any combination thereof, for the at least one instance of the preamble sequence in the extracted set of the at least one instance of the preamble sequence.

18. The method according to claim 16, wherein the NN is executable to output at least the physical root sequence index and the associated cyclic shift value, and further comprising determining a logical preamble index for the at least one instance of the preamble sequence in the extracted set of the at least one instance of the preamble sequence based on the output physical root sequence index and the associated cyclic shift value.

19. The method according to claim 16, wherein the NN is further executable to determine the physical root sequence index for the at least one instance of the preamble sequence in the extracted set of the at least one instance of the preamble sequence based on a first set of configuration information indicating a predetermined subset of applicable physical root sequence indices among which to limit the determination of the physical root sequence index.

20. The method according to claim 19, wherein the first set of configuration information comprises a first vector indicating the predetermined subset of applicable physical root sequence indices.
